(19) United States
(12) Patent Application Publication
(10) Pub. No.: US 2023/0110897 A1
(43) Pub. Date: Apr. 13, 2023

(54) ONLINE PLANNING SATISFYING CONSTRAINTS

(71) Applicant: Intrinsic Innovation LLC, Mountain View, CA (US)

(72) Inventor: Kenneth Alan Kansky, Hayward, CA (US)

(21) Appl. No.: 17/955,480

(22) Filed: Sep. 28, 2022

Related U.S. Application Data
(60) Provisional application No. 63/249,483, filed on Sep. 28, 2021.

(51) Int. Cl. B25J 9/16

(52) U.S. Cl. CPC B25J 9/1661; B25J 9/1664

(57) ABSTRACT

Methods, systems, and apparatus, including computer programs encoded on computer storage media, for generating a motion planning for a robot. One of the methods includes receiving data representing a motion specification for performing a task by a robot in an environment. The motion specification specifies a goal and one or more constraints. An initial motion plan is determined based on the motion specification, where the initial motion plan specifies a trajectory that satisfies the one or more constraints of the motion specification. The initial motion plan is executed by the robot. Sensor data is monitored for detecting a change in the environment. A first updated motion plan is generated for the robot based on the first change in the environment. The first updated motion plan is executed by the robot.

### CROSS-REFERENCE TO RELATED APPLICATION

This application claims priority to U.S. Provisional Application No. 63/249,483, filed on Sep. 28, 2021. The disclosure of the prior application is considered part of and is incorporated by reference in the disclosure of this application.

### BACKGROUND

This specification relates to robotics, and more particularly to motion planning for robots under particular constraints.

Robotic manipulation tasks often heavily rely on sensor data in order to complete the task. Sensor data generally capture a state of an environment in which a robotic system performs corresponding tasks. A robotic system can, using sensor data, determine a motion plan for controlling the movement of one or more robots in the environment to perform respective tasks. For example, by following a determined motion plan, a warehouse robot that moves boxes can be programmed to use camera data to pick up a box at the entrance of a warehouse, move it, and put it down in a target zone of the warehouse. For another example, by following another motion plan, a construction robot can be programmed to use camera data to pick up a beam and put it down onto a bridge deck.

### SUMMARY

This specification describes techniques related to online planning satisfying one or more constraints. More specifically, the described techniques include determining or receiving a motion specification for moving one or more robots within an environment; determining an initial motion plan for the one or more robots based on the motion specification; executing the motion plan by the one or more robots; monitoring one or more changes in the environment; and generating an updated motion plan for the one or more robots based on the one or more changes in the environment. In some implementations, the described techniques further include monitoring additional changes in the environment for a second time, generating another updated motion plan based on the additional changes in the environment, and executing the other updated motion plan by the one or more robots until an end condition is met.

In a first example, the method and system can include: determining a motion specification that defines one or more goals (tasks) (e.g., a series of goals or sub-goals) for a robot (e.g., robotic arm and end effector), one or more constraints on feasible operating space, the feasible range of motion of the robot, and on how to reach the one or more goals; determining an initial motion plan for the robotic arm and/or end effector to accomplish the goal given the constraints; monitoring the environment for detected changes in object and/or obstacle properties (e.g. positions, surface textures, colors); updating a current motion plan based on the detected changes, wherein the current motion plan is initialized to refer to the initial motion plan; executing the updated motion plan; and continuously updating the current motion plan (e.g., initialized to refer to the initial plan and modified to refer to each updated plan) until the goals of the motion specification are accomplished.

Monitoring the environment can include continuously streaming new environment states using a sensor suite (e.g. cameras, depth sensors, force-torque sensors, motor position sensors, etc.). When changes in the environment are detected, a new estimate of an object pose can be used to update a motion plan. The motion plan can be updated by determining a new motion plan using the new estimate of the object pose and blending the new motion plan with the current motion plan to intersect the robot’s current kinematic state, including all joint positions and velocities. After blending, the new motion plan can be used as the current motion plan (e.g., the plan that the robot executes asynchronously while computing the next updated plan). The term “blending” generally refers to reconciling discrepancies between the new motion plan and the previously-determined motion plan (e.g., an initial motion plan). The discrepancies can be introduced due to the motion of a robot following a previously-determined motion plan from a first state to a second state during the time when the system is computing the new motion plan based on the first state.

In an illustrative example, the system receives a motion specification specifying a goal and motion constraints for each of a set of motion segments. In other words, the system does not necessarily determine a motion specification for motion planning. The goal can include a target pose (e.g., defined by a constraint on a pose, defined below), a hold duration, a relationship to other goals (e.g., retract the gripper by a predetermined distance from wherever it will grasp an object), and/or other parameters. The motion constraint can include: a pose constraint on a pose (e.g., an isometric transform in Euclidean space), including a target frame for constraint interpretation, a reference frame for an actor (e.g., robot), a set of translational parameters limits (e.g., a space of valid values), and/or a set of rotational parameter limits (e.g., a space of valid values); an acceleration constraint; a force torque constraint; and/or other constraints.

An initial motion plan, including a set of initial motion segments (e.g., one or more motion segments arranged in a sequence), can be generated based on one or more motion specifications using an offline planner (e.g., defined below). Each initial motion segment can include: the trajectories for the segment, the motion specification (and/or the goal from the respective motion specification), estimated time of execution, and/or a prediction of the state of the environment that will result from a motion (e.g., pushing a box, opening a door, etc.). The initial motion plan and/or other motion plans determined and used by the method can additionally or alternatively be represented using behavior trees, model predictive control, state machines, decision graphs in which edges correspond to motor commands and nodes correspond to decisions, and/or any other motion representation.

The initial motion plan is then provided to an online planner (e.g., online, force-torque compliant, constraint-satisfying system; etc.), which dynamically adapts the trajectory of the initial motion segment (e.g., in real-time) to changes in the world state (e.g., determined by the sensor suite), controls robot operation via an online controller (e.g., online trajectory controller), and/or continuously optimize the motion plan (e.g., even when the environment state does not change, such as reducing the duration of the planned trajectory). The online planner can also adapt the trajectory to forces and/or torques sensed on the end effector or other part of the robot (e.g., in compliance with the motion constraints; at the control rate of the arm, such as 125 Hz, 250 Hz, etc.). The trajectory can be adapted in light of (e.g., in compliance with) the respective motion specification, wherein all (or the highest-priority) constraints remain satisfied by the updated trajectory. The online planner can adapt the trajectory for the current motion segment, for N (e.g., some, all) future motion segments, and/or for other motion segments.

In this illustrative example, adapting the trajectory can include: smoothing the trajectories from the prior motion plan (e.g., the initial motion plan, a subsequently-modified motion plan, etc.) to minimize its length; adjusting the trajectory to compensate for the current force-torque measurement; determining an idealized trajectory by projecting the trajectory back within the constraints (e.g., specified by the motion specification for the motion segment; projected into the solution space; etc.); optionally blending the idealized trajectory to intercept the arm’s current position and velocity; optionally resampling the discretization for discretized trajectories (e.g., to add or remove points); and finding an optimal time parametrization of the trajectory (e.g., using TOPP-RA). However, the motion specification and associated motion planning can be otherwise defined and executed.

Particular embodiments of the subject matter described in this specification can be implemented to realize one or more of the following advantages. First, the method and system can enable a high-level specification for a motion planning task, wherein the motion planning task can be defined using goals and constraints on sequences of motion segments. The high-level specification can enable users to define a limited set of behaviors (e.g., robot actions) to perform a function that previously would have required a large set of behaviors (e.g., more than 30, more than 40, more than 50, more than 100, between 20-100, etc.). The high-level specification can enable users to define one or more reference frames and an end goal’s constraints and relationships for a particular motion planning task. In some embodiments, the motion specification can refer to many reference frames (e.g., to define an end effector motion in the reference frame of an object to grasp, then define the next motion in the reference frame of the container where the object should be released). The high-level specification can be used by both offline planners (e.g., to generate an initial motion plan) and online planners (e.g., to reactively accommodate changes in the environment) while satisfying the constraints imposed by the goals. In some variants, the motion planning task can be specified in prose, wherein the system can automatically interpret and apply constraints associated with the prose-based specification. For example, the motion planning task may be specified as “keep the water glass upright,” which can be converted to a motion constraint of maintaining a vertical axis of the water glass within a predetermined range of a gravity vector. The term “prose” generally refers to verb phrases or sentences in one or more human natural languages, and in some implementations, one or more adapted human natural languages required by a particular input syntax. In some implementations, a system can process a prose specifying a motion planning task and generate corresponding programming languages representing the motion planning task so that the task is perceivable by one or more computers. One example technique can include using one or more natural language processing models or algorithms to process proses specifying motion planning tasks, e.g., a recurrent neural network, a self-attention autoencoder, or other suitable models.

Second, the method and system can enable periodic and/or aperiodic real-time updates to the motion plan, possibly in response to detected changes in the environment, while continuing to satisfy the constraints and goals of the high-level specification, wherein the constraints can refer to entities in the environment, refer to valid robot motion, and/or any other entity. For example, a constraint may require moving the end effector above an object to grasp, so if the object moves, the constraint requires the end effector to also move.

The new motion plan can additionally or alternatively be calculated to improve a current motion plan (e.g. reduce duration, spatial path length, reduce maximum acceleration, etc.). In addition, the system can dynamically incorporate state changes of one or more robots into executing the new motion plan, which further improves the efficiency and accuracy of the new motion plan. More specifically, the new motion plan can be used (e.g., by the robot) in real-time by efficiently transitioning from a motion plan that a robot is currently executing to the new motion plan. For example, the system can dynamically “blend” the new motion plan with a previous motion plan for accurately controlling a robot in real-time.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of schematic representation of the method.

FIG. 2 illustrates an example of schematic representation of the system.

FIGS. 3A-B illustrate an example of embodiment of the system.

FIG. 4 illustrates an example embodiment of a computing system.

FIG. 5 illustrates an example embodiment of the method.

FIG. 6 illustrates an example process of updating a motion plan.

FIGS. 7A-Dillustrate one example scenario of implementing the method by the system.

FIGS. 8A-E illustrate an example of a motion specification, where each Figure illustrates a different motion segment of a singular motion specification.

Like reference numbers and designations in the various drawings indicate like elements.

### DETAILED DESCRIPTION

The described techniques generally relate to generating a motion plan for controlling a robot to perform a task in an environment after processing a motion specification using an offline planner module, or an online planner module, or both, and updating the motion plan for the robot based on observed or perceived changes in the environment. The described motion specification includes data defining one or more goals and motion constraints associated with the goals. In some implementations, the motion specification can include a sequence of motion segment specifications, and each motion segment specification can define a sub-goal for achieving a goal, and further define one or more respective constraints associated with the sub-goal.

In some implementations, the system incorporates various techniques to generate the updated motion plan based on environment changes, and to control a robot in real-time, the system dynamically incorporates the updated motion plan with a previous motion plan that a robot is currently executing by taking into consideration potential state changes of a robot when the updated motion plan is under computation. Note that the term “previous motion plan” (also referred to as a previously-determined motion plan in the following specification) generally refers to a motion plan determined at a time earlier than the current time. A previous motion plan can include the most recently updated motion plan, a motion plan updated before the most recently updated motion plan, a motion plan that is initially determined, or any other suitable motion plans.

### 1. System

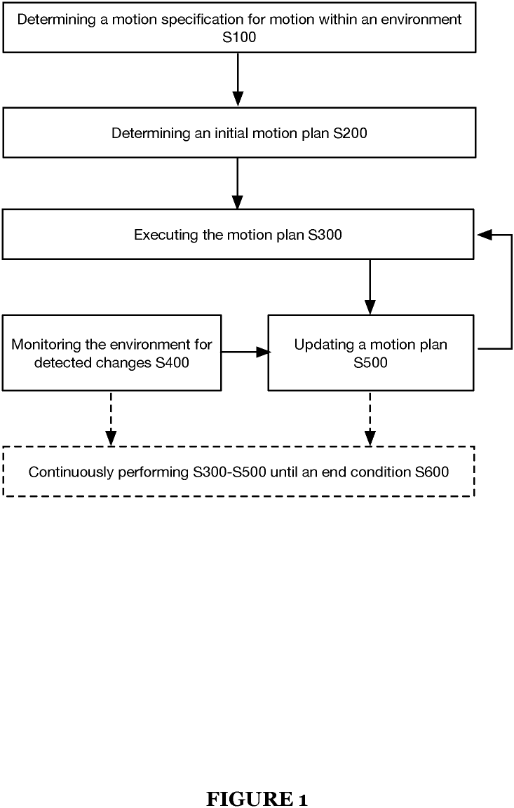

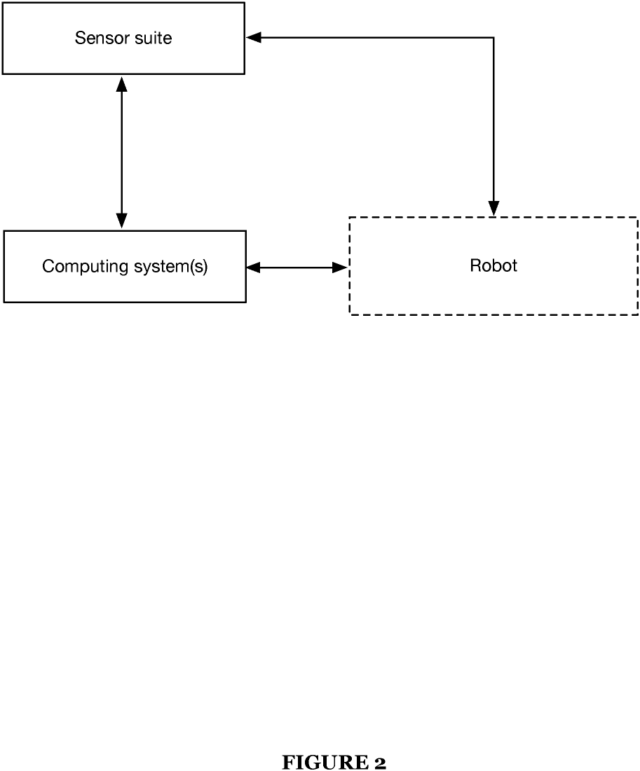

The described method can be performed by a system, for example, as shown in FIG. 2. If the system of FIG. 2 is properly configured, the system can perform the operations or processes substantially similar to those shown in FIG. 1 (e.g., S100-S600). In general, the system can be implemented on one or more computers in one or more locations, in which systems, components, and techniques described below can be implemented. Some of the components of the system can be implemented as computer programs configured to run on one or more computers. The system can further include any suitable engines or algorithms configured to generate, update, and tweak the motion plans after processing data representing environment changes. As illustrated in FIG. 2, an example of schematic representation of the system can include one or more of a computing system, a robot, or any other suitable components. The robot can include one or more of an end effector, a robotic arm, a sensor suite, or other components.

A computing system as shown in FIG. 2 can include and/or be used with one or more modules. In general, the one or more modules can be configured to generate a motion plan for controlling a robot by processing a motion specification, determining one or more changes in an environment, and generating an updated motion plan based on the determined one or more changes in the environment.

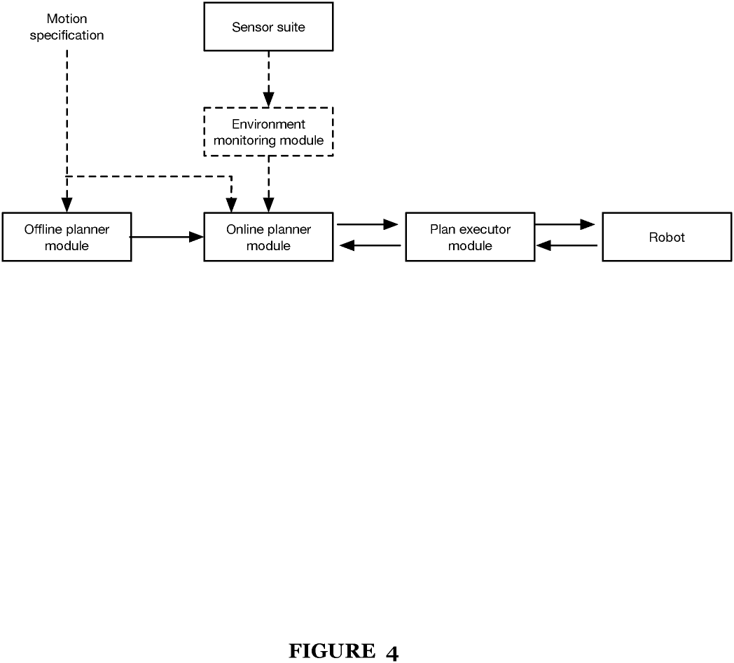

Referring to FIG. 4, an example embodiment of the computing system of FIG. 2 can include one or more of an offline planner module, an online planner module, an environment monitoring module, a plan executor module, or any other suitable module. The example embodiment of the computing system in FIG. 4 can preferably function to perform one or more steps of the method of FIG. 2, but can additionally or alternatively provide any other suitable functionality. The computing system can be local to the robotic arm, remote, and/or otherwise located. The computing system can include a control system, which can control the robotic arm, end effector, visual systems, and/or any other system component. The control system can be wirelessly connected, electrically connected, and/or otherwise connected to one or more components of the system. However, the computing system can be otherwise configured.

The offline planner module can function to determine an initial motion plan for the method, and/or any other suitable functionality. The offline planner module can output a motion plan that can later be executed to dictate the motions of a robot. Offline planners can ingest information about the future state of the environment, including where objects will be located, expected joint positions and velocities, and/or any other information. The offline planner module can be a sampling-based planner, a grid-based planner, interval-based planner, geometric based planner, artificial potential field planner, and/or any other suitable planner. The planner can be a tree-based planner, a graph-based planner, and/or any other suitable planner. In a specific example, the planner can be a constrained RRT, and/or any other suitable planner.

The online motion planner can function to perform incremental updates to a current motion plan (e.g., determine a new motion plan) in order to improve the plan without using new information about the environment and/or using new information about the environment (e.g., the environment state received from the environment monitoring module). The online motion planner can compute a new motion plan in real time (e.g., less than 30 ms) or near real time (e.g., less than 60 ms). The online motion planner can use the motion specification so that the online motion planner can determine which parts of the motion plan must satisfy constraints defined in the motion specification. The new motion plan can be used by the plan executor module to transition from the current motion plan to the new motion plan (e.g., during or concurrently with robot execution of the current motion plan), a robot controller module, and/or any other suitable controller module.

In a specific example, a new motion plan with new joint velocity commands can be determined (e.g., anew) and sent to the robot controller module, wherein the robot controller module executes the new motion plan. However, the online motion planner can be otherwise configured.

The environment monitoring module can function to monitor the environment (e.g., physical scene surrounding the robot and/or workspace; all physical objects that a robot could move or manipulate), receive data from the sensor suite, and/or update a perception about a state of the environment (environment state). The environment state can include raw sensor values, transformed sensor values, and/or any other information and can be sent to the online motion planner to update the current motion plan. The environment monitoring module can include one or more motion tracking algorithms, one or more machine learning algorithms that can detect movement and/or other changes in images (e.g., neural networks, clustering algorithms, etc.), and/or any other suitable algorithm. However, the environment monitoring module can be otherwise configured. In an example, the environment monitoring module can output an environment state based on sensor values from the sensor suite, past environment values, and/or other information. In a specific example, the environment state can include the sensor values and/or other estimated beliefs about environment properties. The environment state can be passed to both the offline and online planners. Environment state computation can be concurrent with the online planner’s computation, with robot execution, and/or otherwise timed. The environment monitoring module can output updated environment states at a frequency that is independent from the online planner’s frequency of computing updated plans, or at any other suitable frequency.

More specifically, the system can perform different operations using different modules concurrently and asynchronously (e.g., at different rates or frequencies). The system specifies a first group of frequencies for transmitting motion plans, sets of robotic commands to a robot, and sending feedback signals. The first group of frequencies can be, for example, between 1-500 Hz, between 60-80 Hz, between 120 Hz - 260 Hz, 125 Hz, 250 Hz, less than 120 Hz, more than 260 Hz, etc.

In addition, the system specifies a second group of frequencies for perceiving changes in the environment. One or more computers can be configured to monitor and process sensor data at a range of frequencies of, for example, less than 10 Hz, more than 10 Hz, more than 100 Hz, more than 200 Hz, etc.

Furthermore, the system specifies a third group of frequencies for computing a new motion plan based on the perceived environment changes. A planner module (e.g., an offline planner module or an online planner module) can be specified to determine a new motion plan at a range of frequencies of, for example, less than 10 Hz, 10 Hz, more than 10 Hz, between 9-11 Hz, between 8-12 Hz, etc.

It should be noted that the three groups of frequencies can be distinct or overlap, which can be adjusted and determined according to different requirements of controlling robots, monitoring changes in the environment, and updating motion plans. In addition, the above-noted groups of frequencies do not need to be constant throughout the execution of the described method by the system. In fact, the groups of frequencies can change in values over time.

As an example scenario for real-time controlling a robot to execute a motion plan, the plan executor module first generates a sequence of robotic commands based on a previous motion plan and transmits signals to control the robot at a first frequency (e.g., 125 Hz or 250 Hz, or equivalently, 4 milliseconds or 8 milliseconds per controlling cycle). Meanwhile, the system perceives changes in the environment at a second frequency (e.g., 50 Hz, 100 Hz). The perception rate can generally be slower than the controlling rate. After detecting one or more changes in the environment, the system generates a new motion plan at a third frequency to meet the constraints of the motion specification within the new environment. The third frequency for generating the new motion plan can be smaller than the first frequency for controlling the robot. For example, the third frequency can be 10 Hz or 20 Hz, depending on various updating requirements. In some implementations, the system can compute multiple updated motion plans, each based on a previous motion plan given the same or different changes perceived in the environment at the same or different times. These multiple updated motion plans are transmitted to the plan executor module, which is configured to generate control commands as soon as the plan executor module receives one or more of the multiple updated motion plans.

The plan executor module continues transmitting commands according to the previous motion plan to control the robot until receiving data representing the new motion plan. The plan executor module adapts the new motion plan with the previous motion plan to reconcile state changes of the robot during the time when the new motion plan was under computation.

It should be noted that one or more perceived changes in the environment might or might not cause the initial motion plan or a previously determined motion plan to no longer satisfy the constraints prescribed in the motion specification, and in either situation, the system can generate a new motion plan in observation of the environment changes. For example, in a situation where a previously determined motion plan still satisfies constraints given the changes in the environment, the system can generate a new motion plan for different purposes, e.g., reducing the energy cost, the operation time, or other suitable purposes. In addition or alternatively, the system can update a motion plan given the environment changes to maximize a probability that the constraints will remain satisfied when the one or more robots execute the updated motion plan. To maximize the probability, the system can, for example, adjust the motion plan so that the trajectory is as far as possible away from the constraint boundaries. In a situation where the changes in the environment cause a previously determined motion plan to no longer satisfy the constraints, the system can accordingly generate a new motion plan to meet the constraint requirements.

The environment (e.g., world) can be a space where one or more robots operate within. The environment can include one or more properties (e.g., light, color, object positions, trimeshes, surface normals, etc.). At a particular point in time, the environment can be associated with an environment state, which is a set of values of the properties of the environment at that time. The environment can include: conveyor belts, containers, objects, structures, and/or any other component. However the environment can be otherwise configured.

The plan executor module can function to receive and read the new motion plan from the online planner module and transition to the new motion plan from the current motion plan while the current motion plan is being executed. The plan executor module can include any online planning algorithm (e.g., from the online planner module and/or any other suitable online planning module). The plan executor module can include a braking module that functions to generate a safety braking sequence, which can enable the robotic arm to slowly and/or closely approach objects and/or obstacles. The plan executor module can validate changes from the current motion plan to the new motion plan, can raise errors if the new motion plan deviates a predetermined distance from the current controllable joint positions, and/or perform any other function. The plan executor module can provide feedback to the online planner module. The feedback can include: current controllable joint positions and latency between the current motion plan and the physical realization of the current motion plan, and/or any other suitable feedback. The plan executor module can log all current and/or new motion plans for visualization of how the motion plan is modified over time. The plan executor module can output motor commands in the form of control law setpoints, such as target joint velocities, joint torques, dynamical system parameters, and/or other setpoints. Alternatively, the plan executor module can output control instructions, a full motion plan, and/or generate any other suitable output. However the plan executor module can be otherwise configured.

The end effector of a robot in the environment preferably functions to grip an object. The end effector can be impactive, ingressive, astrictive, contigutive, and/or any other suitable type of end effector. In a first example, the end effector is a suction gripper. In a second example, the end effector is a claw gripper (e.g., dual prong, tri-prong, etc.). The end effector can be actuated: electrically (e.g., servo/motor actuation), pneumatically, hydraulically, unactuated (e.g., passive deformation based on motion of robotic arm, rigid body, etc.), and/or otherwise actuated. However, the system can include any other suitable end effector. The end effector is preferably mounted to the robotic arm, but can additionally or alternatively be mounted to and/or transformed by any suitable actuation mechanism(s) (e.g., CNC gantry system, etc.) and/or in any suitable actuation axes (e.g., 6-axis robotic actuation). However, the end effector can be otherwise configured.

The robotic arm can function to position and/or articulate the end effector for grasping an object, manipulate the gripped object in a specific way (e.g., hold an object, move an object, etc.), and/or provide any other suitable functionality. The robotic arm can be articulated by automatic control and/or can be configured to automatically execute control instructions (e.g., control instructions determined based on the grasp point, dynamically determined control, etc.), however the system can alternatively be otherwise suitably controlled and/or otherwise suitably enable end effector articulation. The robotic arm can include any suitable number of joints that enable articulation of the end effector in one or more degrees of freedom (DOF). The arm preferably includes 6 joints (e.g., a 6- axis robotic arm), but can additionally or alternatively include seven joints, more than seven joints, and/or any other suitable number of joints.

The sensor suite can include visual systems, actuation feedback systems, and/or any other suitable sensors. Actuation feedback sensors of the actuation feedback system preferably function to enable control of the robotic arm (and/or joints therein) and/or the end effector, but can additionally or alternatively be used to determine the outcome (e.g., success or failure) of a grasp attempt. Actuator feedback sensors can include one or more of a: force-torque sensor, gripper state sensor (e.g., to determine the state of the gripper, such as open, closed, etc.), pressure sensor, strain gage, load cell, inertial sensor, positional sensors, displacement sensors, encoders (e.g., absolute, incremental), resolver, Hall-effect sensor, electromagnetic induction sensor, proximity sensor, contact sensor, and/or any other suitable sensors. However, the sensors can be otherwise configured. The sensor suite can include a visual system which preferably functions to capture images of the environment, but can provide any other functionality. A visual system can include: stereo camera pairs, CCD cameras, CMOS cameras, time-of- flight sensors (e.g., Lidar scanner, etc.), a range imaging sensors (e.g., stereo triangulation, sheet of light triangulation, structured light scanner, time-of-flight, interferometry, etc.), and/or any other suitable sensor. The sensors can be arranged into sensor sets and/or not arranged in sets. The visual systems can determine one or more RGB images, depth images (e.g., pixel aligned with the RGB, wherein the RGB image and the depth image can be captured by the same or different sensor sets). Imaging sensors are preferably calibrated within a common coordinate frame (i.e., sensor coordinate frame) in a fixed/predetermined arrangement relative to a joint coordinate frame of the robotic arm, but can be otherwise suitably configured. Sensors of the sensor suite can be integrated into the robot, and/or any other component of the system, or can be otherwise mounted to a superstructure (e.g., above a picking bin/container, camera directed toward a picking bin, etc.), mounted to the robotic arm, mounted to the end-effector, and/or otherwise suitably arranged. However, the sensor suite can be otherwise configured.

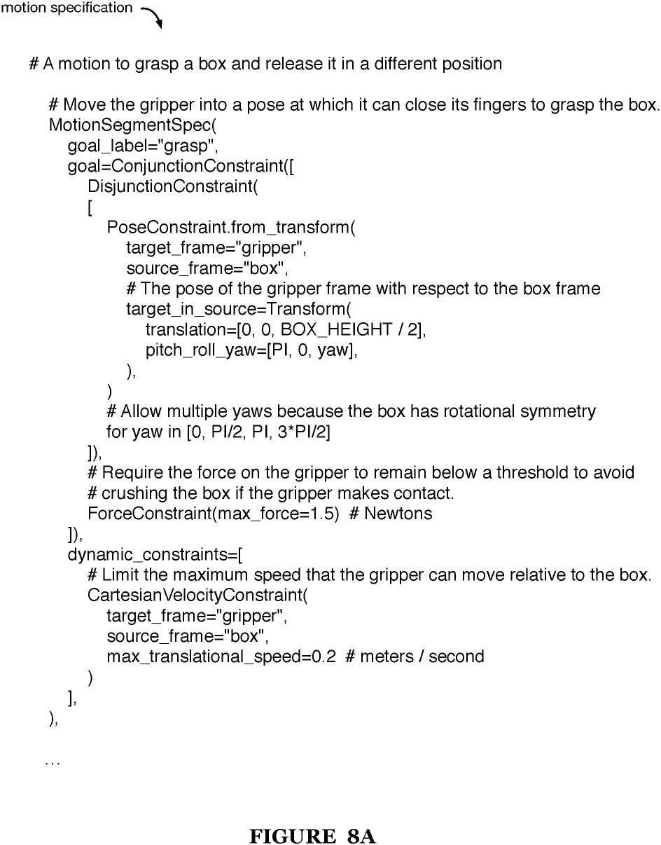

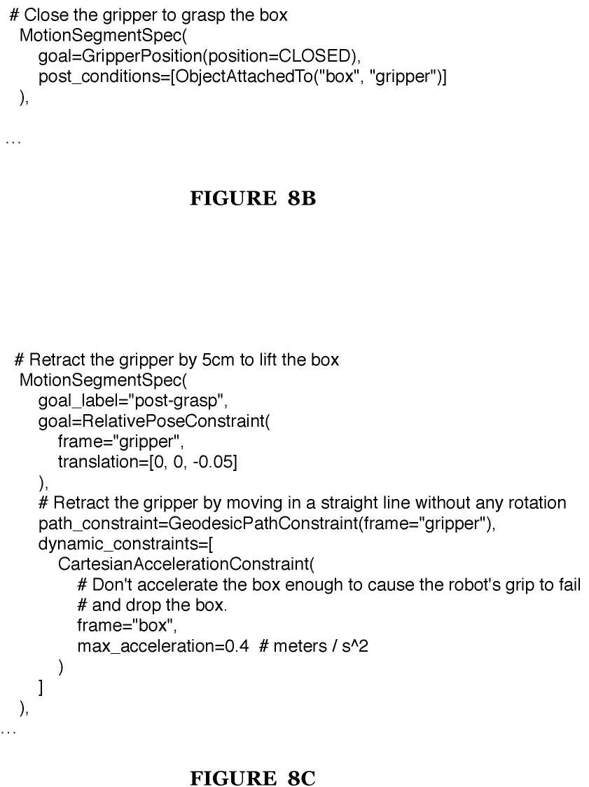

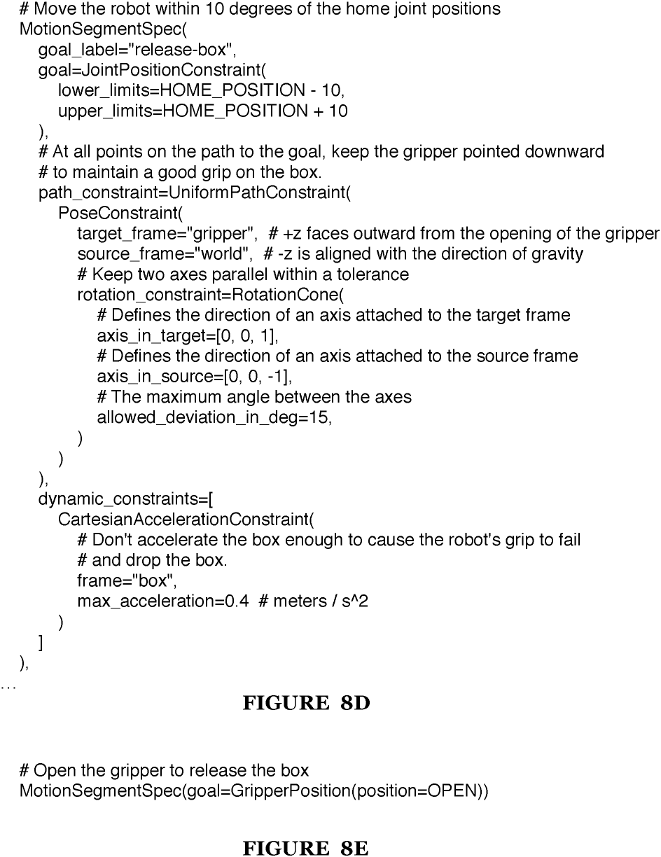

The system can be configured to process a motion specification, which can function to specify information for determining a motion plan. The motion specification can include one or more goals, one or more constraints, one or more motion segment instances, and/or any other suitable information. For example, FIGS. 8A-E illustrate an example of a motion specification, where each figure illustrates a different motion segment of a singular motion specification.

As shown in FIGS. 8A-E, the example motion specification specifies a goal for grasping a box and releasing the box in a different position. To achieve this goal, the motion specification specifies a sequence of motion segment specifications. Each motion segment specification, denoted by the keyword “MotionSegmentSpec,” defines a sub-goal for achieving the goal and one or more constraints associated with the sub-goal.

For example, as shown in FIG. 8A, the sub-goals can include a first sub-goal (e.g., moving the gripper into a pose at which it can close its fingers to grasp the box). The constraints that need to be satisfied for achieving the sub-goal can include a conjunction constraint, denoted by the keyword “ConjunctionConstraint,” and one or more disjunction constraints (e.g., the pose constraint and yaw constraints), which can be denoted by the keyword “DisjunctionConstraint.” A motion plan must satisfy all the constraints listed within a conjunction and at least one of the multiple constraints listed within a disjunction. The details of conjunction constraints and disjunction constraints are described below.

In addition, the example motion specification can also specify a dynamic constraint, e.g., a maximum translational speed value of 0.2 meters/second, which can be denoted by assigning a value to the variable “dynamic_constraints” that is defined by the keyword “CartesianVelocityConstraint.” Furthermore, the first example motion specification can specify a force or torque constraint, e.g., a maximum force value of 1.5 N, denoted by the keyword “ForceConstraint.” The system can use any appropriate collection of keywords for allowing users to define the various types of constraints in the motion specification. Alternatively or in addition to keywords, the constraints can be implemented by libraries that define functions having corresponding names that, when called, generate an internal representation of the constraint using any passed in arguments.

As shown in FIG. 8B, the example motion specification specifies a second sub-goal for achieving the goal, e.g., closing the gripper to grasp the box. In addition, the specification further specifies a condition (also referred to as a “post condition”) that must hold: that the box is attached to the gripper whenever the sub-goal or goal within the motion segment specification is achieved.

As shown in FIG. 8C, the example motion specification specifies a third sub-goal for achieving the goal, e.g., retracting the gripper by 5 cm to lift the box. To achieve this sub-goal, the specification defines a relative pose constraint for translating the gripper according to the gripper’s frame. In general, the system can specify geometric constraints for one or more robots, sensors, or other components in an environment. The term “geometric constraint” generally refers to constraints that involve geometries of a robot, a sensor, or a component in the environment (e.g., constraints on one or more joint angles, gripper positions, or other suitable geometries), or geometries of a reference frame representing the environment (e.g., points, lines, volumes of a space occupied by one or more components in the environment, or other suitable geometries), or both. Note that the reference frame includes a world frame, a robot frame, or a sensor frame, or other suitable frames. The motion specification also includes a dynamic constraint specifying a maximum acceleration (e.g., 0.4 meters/squared second) for translating the box.

As shown in FIG. 8D, the example motion specification specifies a fourth sub-goal for achieving the goal, e.g., moving the robot within 10 degrees of the home joint positions. To achieve this sub-goal, the specification specifies a joint position constraint, denoted by the keyword “JointPositionConstraint,” to define the home position’s lower and upper limits. The motion specification further defines one or more pose constraints, denoted by the keyword “PoseConstraint,” about how the gripper can be oriented while moving from the third sub-goal to the fourth sub-goal. For example, the motion specification includes a rotation constraint specifying a maximum angle between two axes. In addition, the motion specification further defines a dynamic constraint specifying a maximum acceleration of the box (e.g., 0.4 meters/squared second), denoted by the keyword “CartesianAccelerationConstraint.”

As shown in FIG. 8E, the example motion specification further specifies a fifth sub-goal for achieving the goal, e.g., opening the gripper to release the box. The motion specification also specifies a gripper position constraint, denoted by the keyword “GripperPosition,” so that the gripper can be opened to release the box.

The one or more goals can include: object grasping, object insertion, object placement, object movement from point A to point B, and/or any other suitable goals. The goals can be defined in the physical environment using a marker (e.g., colored marker, charuco marker, etc.), using the object type, and/or otherwise defined. The constraints can be: kinematic (velocity, acceleration, etc.), geometric (e.g., bounds on joint angles, end effector poses, pose relative to a target, etc.), force constraints, torque constraints, keypoint-based constraints, and/or any other suitable constraint.

The constraints can: be prioritized (e.g., ordered list, weighted, etc.) or unprioritized. The constraints can have a permitted violation threshold, or not have a permitted threshold. The constraints can be associated with critical failure and/or acceptable failure (e.g., if a constraint is not met) and/or be otherwise configured. The one or more constraints can be defined with respect to one or more target reference frames (e.g., a reference frame of a tracked target marker), and/or any other suitable frame. The goal can be accomplished using one or more reference frames (e.g., on-arm camera, off-arm camera etc.), and/or any other suitable frame.

In some implementations, the motion specification can further include a goal or a sub-goal including conjunction constraints, disjunction constraints, or both. In general, a conjunction of constraints generally refers to constraints that should be concurrently satisfied for determining a motion plan, and a disjunction of constraints generally refers to constraints that at least one of which should be satisfied for determining a motion plan. In other words, conjunction constraints are the intersection among different constraints, and disjunction constraints are the union of different constraints. For a set of constraints in a disjunction, the system can select motion plans or motion segments that require minimal time, control, or energy from all motion plans or segments that satisfy one of the constraints in the set. For a set of constraints in a conjunction, the system can select motion plans or motion segments that require minimal time, control, or energy from all motion plans or segments that satisfy all of the constraints in the set. Conjunctions may also contain disjunctions and vice versa.

However, the motion specification can be otherwise configured.

However, the system can include any other suitable components.

### 2. Method

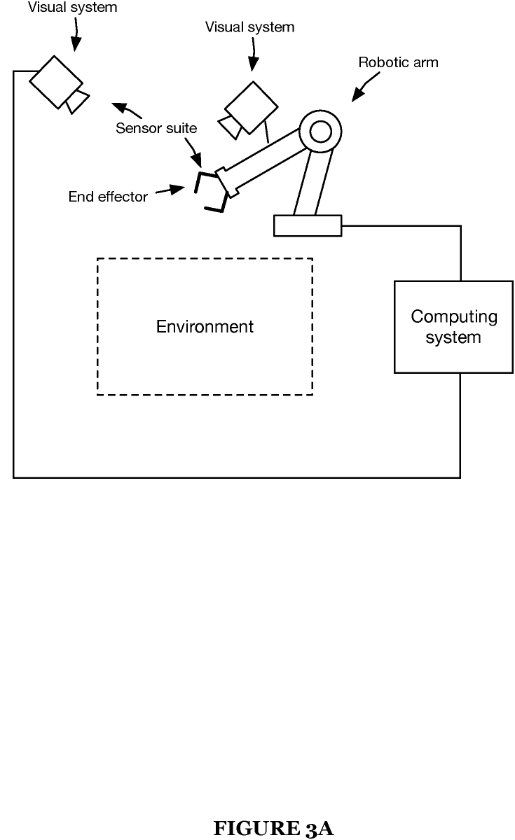

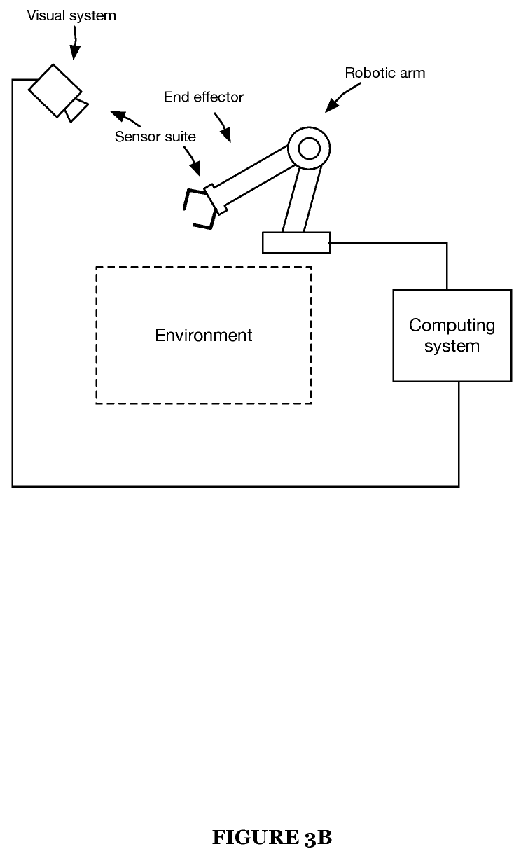

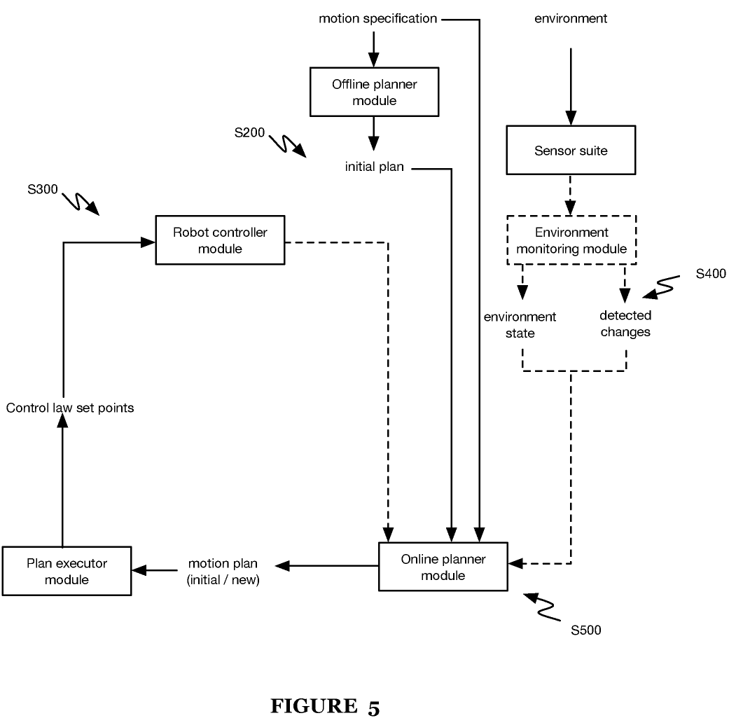

FIG. 1 illustrates an example of schematic representation of the method. As shown in FIG. 1, the method for online planning can include one or more of: determining a motion specification, including constraints, for motion within an environment S100; determining an initial motion plan S200; executing the updated motion plan S300; monitoring the environment for detected changes S400; updating a motion plan S500; and continuously performing S300-S500 until an end condition S600. The method can include an additional operation or step suitable for online motion planning of a robotic system based on environment changes. In addition, FIG. 5 illustrates an example embodiment of the method. The method (e.g., the process of S100-S600) is preferably performed by the system disclosed above. Particularly, the process can be performed by a system of one or more computers located in one or more locations. For example, a system of FIGS. 2, 3A, 3B, or 4, appropriately programmed, can perform the process of S100-S600. However, the above described process can be otherwise performed by a different system or an apparatus.

The method can be performed at a predetermined frequency (e.g., between 1-500 Hz, between 60-80 Hz, between 120 Hz - 260 Hz, 125 Hz, 250 Hz, less than 120 Hz, more than 260 Hz, etc.), performed once, performed in response to a detected change in the environment, and/or performed at any other suitable time. It should be appreciated that the predetermined frequency does not need to be a constant throughout the execution of the described method by the system. In fact, the predetermined frequency can vary in values over time.

Determining a motion specification for motion within an environment S100 can function to determine goals, constraints, and/or any other suitable information to guide one or more robots for operating within the environment. The environment can be a physical environment or a simulated environment. The environment can be indoors, outdoors, a combination, and/or otherwise defined. The motion specification can be determined before an operation session, at the start of an operation session, when a task for one or more robots is determined, and/or at any other suitable time.

The system can determine a motion specification based on data representing a state of an environment and a final goal specified by a user. More specifically, the system can determine one or more motion segments and corresponding constraints given an environment state and a final goal of a robotic task. In some situations, to generate a motion specification, the system can process information including pre-determined or preferred constraints, or motions, or both in addition to the final goal and the environment state.

In a first variant, the motion specification can be received and/or retrieved from a datastore. In other words, the system does not necessarily compute a motion specification. Instead, the system can receive data representing a motion specification for operating a robot in the environment. Generally, the received motion specification can include data defining a final goal and motion constraints associated with the final goal. In some situations, the received motion specification can include a sequence of motion segment specifications. Each of the motion segment specifications defines a sub-goal for achieving the final goal, and each sub-goal is associated with respective constraints.

In a second variant, the motion specification can be transmitted to the computing system from another system. Receipt of the motion specification can trigger a start event for an operation session.

In a third variant, the motion specification can be determined at a user interface associated with the computing system (e.g., determined locally based on user input).

However, the motion specification can be otherwise determined.

Determining an initial motion plan S200 can function to define a plan that can be used to accomplish one or more goals according to one or more constraints of the motion specification from S100. The initial motion plan can be determined by the offline planner module, by the online planner module, and/or by any other suitable planner module. The initial motion plan is preferably determined based on the motion specification, but can additionally or alternatively be determined based on any other suitable information. The initial motion plan is preferably a trajectory (e.g., a function that maps time values to the set points of one or more control laws, wherein a set point can be a desired joint velocity, a desired force on the end effector, etc.), but can additionally or alternatively be a path, and/or any other suitable motion plan. The initial motion plan can be annotated according to the motion specification or unannotated. The initial motion plan can be annotated with elements of the motion specification (e.g., motion segments can be annotated particular constraints, times in the motion plan, such as when a goal is considered completed, etc.). Descriptions for the initial motion plan can be equally applicable to any motion plan generated by the system and/or method.

In a first variant, the initial motion plan can be predetermined and retrieved and/or received with a motion specification.

In a second variant, the initial motion plan can be determined using the computing system, and/or otherwise determined.

However, the initial motion plan can be otherwise determined.

Executing the motion plan S300 can function to control the motion of the one or more robots to achieve one or more goals defined by the motion specification. The executed motion plan can be the initial motion plan from S200, the updated motion plan S400, and/or any other suitable motion plan. S300 is preferably performed after the respective motion plan is determined, but can be performed at any other suitable time. A given motion plan is preferably continuously executed until an updated motion plan is available (e.g., after S500), but can alternatively be intermittently paused (e.g., after execution of a predetermined number of subsegments or motion steps, a predetermined number of motion segments, etc.; upon receiving a signal, such as a button press, etc.; etc.), and/or execute any other suitable set of motion plans or portions thereof. S300 is preferably performed in parallel with S500 (e.g., an updated motion plan is generated for a subsequent motion segment while the motion plan for a preceding segment is being executed), but can alternatively be executed after or before S500. S300 is preferably performed in parallel with S400, but can additionally or alternatively be performed after or before S400. In variants, S300, S400, and S500 can be executed concurrently (e.g., on the same or different computing environment, such a computer, process, or thread, etc.), and/or not be dependent on each other (e.g., do not need to wait for another process to finish before executing; do not need to wait for a new environment state to be output before executing; etc.). In these variants, S500 can be performed in response to (and/or using data from) a prior computation of S400, but can be otherwise performed. The motion plan can be executed by the computing system and/or by any other suitable system. However, the updated motion plan can be otherwise executed.

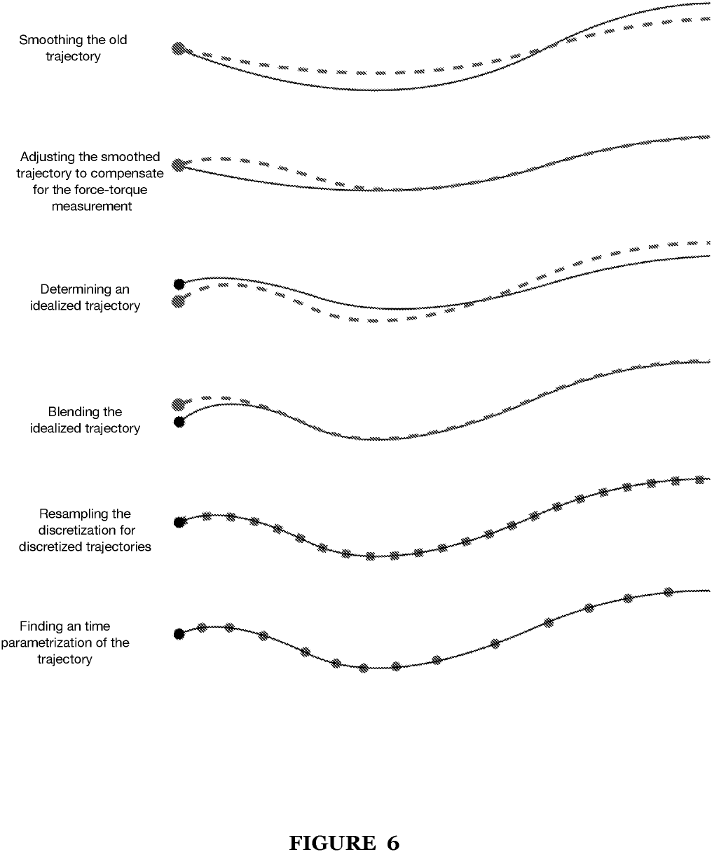

As shown in FIG. 5, to execute an initial motion plan, the system can first transmit data representing the initial motion plan from an offline planner module to a plan executor module. The plan executor module is configured to generate data representing a set of robot control commands by processing the initial motion plan. The set of commands are then transmitted to a robot controller module. In some implementations, the robot controller module is configured to execute the set of commands and cause the robot to operate according to the initial motion plan. The robot controller module can be located on a robot, or off the robot but physically or wirelessly coupled to the robot. In some implementations, the robot controller module can be integrated into an on-board circuit of the robot. Similarly, the plan executor module can process updated motion plans after the initial motion plan by blending the updated motion plans with the initial motion plan or with a previously determined motion plan (e.g., the most recently updated motion plan). The “blending” process is described in greater detail below in connection with FIG. 6.

Monitoring the environment for detected changes S400 can function to monitor physical properties of the environment. The environment can be monitored using the computing system, such as using the environment monitoring module, and/or any other suitable module; and/or any other suitable system. A detected change can include a new location of an object (e.g., after object movement), movement of a target location, and/or any other suitable movement or change. The detected changes can be observed between a first image to a second image occurring at different times, and/or observed in any other suitable media. The detected changes can be monitored in real time, near real time, at a predetermined time (e.g., when the monitoring experiences lag), at a predetermined frequency, and/or at any other suitable time. The detected changes can be monitored for at a predetermined frequency (e.g., less than 10 Hz, more than 10 Hz, more than 100 Hz, more than 200 Hz, etc.), and/or at any other suitable frequency. It should be appreciated that the predetermined frequency does not need to be a constant throughout the execution of the described method by the system. In fact, the predetermined frequency can vary in values over time.

In a first variant, the detected changes can be determined using a visual system that uses motion tracking techniques to determine changes in the environment.

In a second variant, the detected changes can be determined by comparing frames captured at two different times to determine changes in the environment.

However, the detected changes can be otherwise determined.

Updating a motion plan S500 can function to update the current motion plan (e.g., which can be initialized to refer to the initial motion plan and can be updated by the method), and/or any other suitable motion plan. Updating the motion plan can function to incrementally update a trajectory based on the detected changes from S400; incrementally update a trajectory to reduce a trajectory runtime; and/or otherwise update a motion plan. Updating the motion plan can function to recalculate an entire trajectory or a portion of a trajectory, such as an unexecuted portion. Alternatively, a next motion segment can be recalculated and blended with the current motion segments, and/or the next and all future motion segments can be recalculated. However, updating the motion plan can include any other suitable functionality. The details of blending an updated motion plan with a previous motion plan are described below in connection with FIG. 6.

Updating the motion plan is preferably performed using the computing system, but can additionally or alternatively be performed by any other suitable system. The motion plan is preferably updated based on the motion specification (e.g., wherein the motion specification is provided with the current trajectory to the online planner module), but can alternatively not be updated based on the motion specification. In variants, the online planner module can determine a new motion plan and/or new motion segments, and the plan executor module can execute the new motion plan in lieu of the current motion plan.

In some implementations, after receiving the updated motion plan from the online planner module, the plan executor module can further adjust the updated motion plan according to the current state of a robot. For example, the plan executor module can determine a state change of a robot during the time period the updated motion plan was calculated and transmitted (e.g., the robot can execute a previous motion plan to move from a first state to a second state during the time period), and blend a first portion of the updated motion plan with the current state of the robot so that the robot can properly execute the rest of the update motion plan accurately. The details of adjusting the updated motion plan are described below in connection with FIG. 6.

The new motion plan can be calculated and used to update a motion plan after a detected change in S400; at a predetermined frequency (e.g., less than 10 Hz, 10 Hz, more than 10 Hz, between 9-11 Hz, between 8-12 Hz, etc.); and/or at any other suitable time. More specifically, the system can perform various techniques to harmonize with the environment changes, e.g., solving a backward kinematics problem. In some implementations, the system can determine constraint changes for the motion specification based on the detected environment changes and propagate the constraint changes through each motion segment of a previously determined motion plan (also referred to as a trajectory). To propagate the constraint changes, the system can perturb solutions at one or more time steps of the motion plan and search for possible poses or configurations of a robot in a search space. Once a new solution is determined for a time step, the system can propagate the updated solution forward, backward, or both along the trajectory. In some implementations, the system can determine whether to apply the constraint changes to all time steps of the motion plan and search for possible poses of a robot at respective time steps so that the possible poses could satisfy the constraint changes for all time steps.

The system can terminate at generating an updated motion plan when it reaches a stopping point. For example, the system can define a stopping point based on a time threshold value, an iteration threshold value, or a convergence threshold value. More specifically, a time threshold value can specify a threshold value for generating an updated motion plan; an iteration threshold value can specify a total number of iterations for searching for a possible pose of a robot; and a convergence threshold value can specify a minimal accuracy that a possible pose should satisfy.

In general, the motion plan can be updated by: calculating a new motion plan; modifying the starting state of the new motion plan to match the current state of one or more robots (e.g., by aligning the joint velocities of the new motion plan with those of the current state of the one or more robots), and/or aligning any other elements; and updating the current plan to the new motion plan.

In some implementations, the system can continuously perform operations of S300, S400, and S500 until reaching an end condition (S600). More specifically, while the robot is executing a motion plan (e.g., similar to S300) for one or more time steps, the system can monitor data representing a new change in the environment using one or more sensors (e.g., similar to S400). Based on the new change in the environment, the system can generate another motion plan to reconcile the new environment change using an online planner module (e.g., similar to S500). The system can then transmit the newly updated motion plan to the plan executor module to control the robot’s operation according to the newly updated motion plan.

The system can define various end conditions. An example of an end condition can include a time point when the robot achieves a goal or sub-goal. In some implementations, the end condition can define a time threshold value for a robot to perform a task or a total number of times to perform a task repeatedly. In some implementations, the end condition can define the number of times a robot is allowed to fail at performing a task.

FIG. 6 illustrates an example process of updating a motion plan. As described above, an online planner module can be configured to generate a new motion plan based on different data, e.g., based on the detected change from S400, based on constraints from the motion specification for future motion segments, based on feedback from the plan executor module (e.g., the latency between when movement commands are sent to the robot, when the robot will physically execute these commands, and when the sensor suite can measure the change in the environment), and/or any other suitable information.

The online planner module is configured to further optimize the new motion plan. In general, possible trajectories for achieving a goal and satisfying corresponding constraints are not unique. Accordingly, for each segment in the new motion plan, the online planner module can select one motion segment from multiple possible motion segments to improve the performance of the new motion plan, e.g., the new motion plan can have a minimal distance, cost a minimal time, or require minimal controls. For example, the new motion plan can be smoothed to minimize the length of the new motion plan using one or more smoothing algorithms (e.g., additive smoothing; exponential smoothing; Elastic bands, Gaussian processes; filters, such as Kalman, Butterworth, Chebyshev, Digital, Elliptic, etc.; etc.).

The new motion plan can be adjusted to compensate for the current force-torque sensor measurement, and/or any other suitable measurements. More specifically, for a task where contact between a robot end effector and an object (e.g., grasping, pressing, or other forms of contact) is required by constraints, the online planner module can ensure the contact by prescribing a force-torque requirement. To satisfy the force-torque requirement, the online planner module can determine a relation between (i) a pose of a robot (or an end effector of the robot) or a relative position between a robot and a target object and (ii) a force or torque applied on the object, by monitoring a reaction force applied on the robot by one or more sensors when the robot contacts the target object.

The online planner module can then determine an adjustment of the new motion plan based on the relation and the force-torque requirement. In some implementations, the online planner module can receive data representing the above-note relation. Although the adjustment for compensating the force-torque requirement often occurs at a beginning portion of a new motion plan, as shown in FIG. 6, it should be appreciated that the force-torque requirement can occur at any time step of the new motion plan.

The new motion plan can be projected into satisfaction of the constraints (e.g., to ensure satisfaction of the one or more constraints within a feasible motion space defined by the constraints). The projected motion plan can be idealized (e.g., the starting position of the new motion plan can be different from a robot’s current position, such as if the robot’s current position does not satisfy the constraints), and/or otherwise configured. For example, an object could have changed position (e.g. due to human intervention) from a previous position that was used to determine the current motion plan (currently executing motion plan).

To solve this problem, the start of the new motion plan can be blended to start the plan from the current robot position (e.g., when the planned start position and the current robot position are different). More specifically, the online planner module can transmit data representing the new motion plan to a plan executor module configured to generate a sequence of commands for controlling a robot based on motion plans. After receiving the new motion plan, the environment monitoring module determines a change of the pose or the position of a target robot due to the target robot performing operations following a previous motion plan during a time period when the new motion plan was calculated and transmitted to the plan executor module. The online planner module can tweak the beginning portion of the new motion plan to compensate for the pose changes of the target robot. In this way, the system can reconcile discrepancies between (i) the current environment state and (ii) the new motion plan determined for a robot based on the previous environment state. One example technique to blend the new motion plan with a previous motion plan can include one or more algorithms configured to compute a motion with minimal time that transitions the robot from one state (e.g. its current real joint positions and velocities) to a state on a given trajectory (e.g. on a new motion plan).

After blending the new motion plan with the previous motion plan, the plan executor module can generate a set of commands that, when executed, cause the robot to operate according to the blended new motion plan.

The new motion plan can be optionally resampled (e.g., when the motion plan is discretized). Resampling the new motion plan can include adding and/or removing points from the new motion plan.

A time parameterization of the new motion plan can be determined, such as using TOPP-RA, Gaussian processes and/or any other technique. The time parameterization of the new motion plan can be used by S500 to execute the new motion plan. In variants, the new motion plan can be executed in sync with a clock, which may be part of the computing system or the sensor suite (e.g. to measure the passing of time).

In a second variant, updating a motion plan can include using measurements from the force-torque sensor to adapt a motion plan (e.g., initial, current, etc.) to forces on the end effector, such that the motions by the robot are compliant to external forces, typically caused by contact between the robot and other objects.

However, the motion plan can be otherwise updated.

Continuously performing S300-S500 until an end condition S600 can function to continuously update the motion plan executed by the one or more robots until one or more goals specified by the motion specification are achieved. The end condition can be defined by the motion specification (e.g., actual object position is the same as the object position specified by the goal in the motion specification, the object is successfully grasped by the robot, etc.), and/or otherwise determined. However, the method steps can be otherwise performed.

### 3. Illustrative Examples

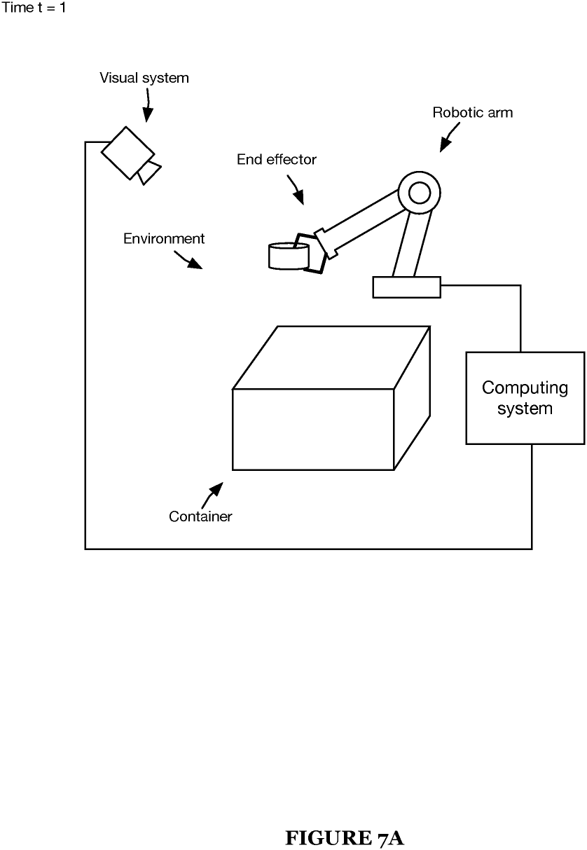

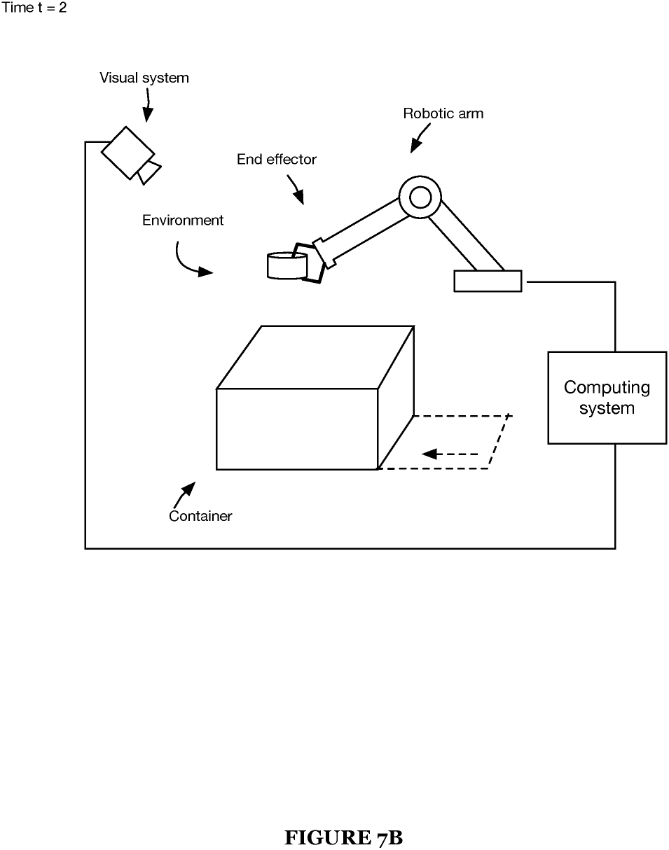

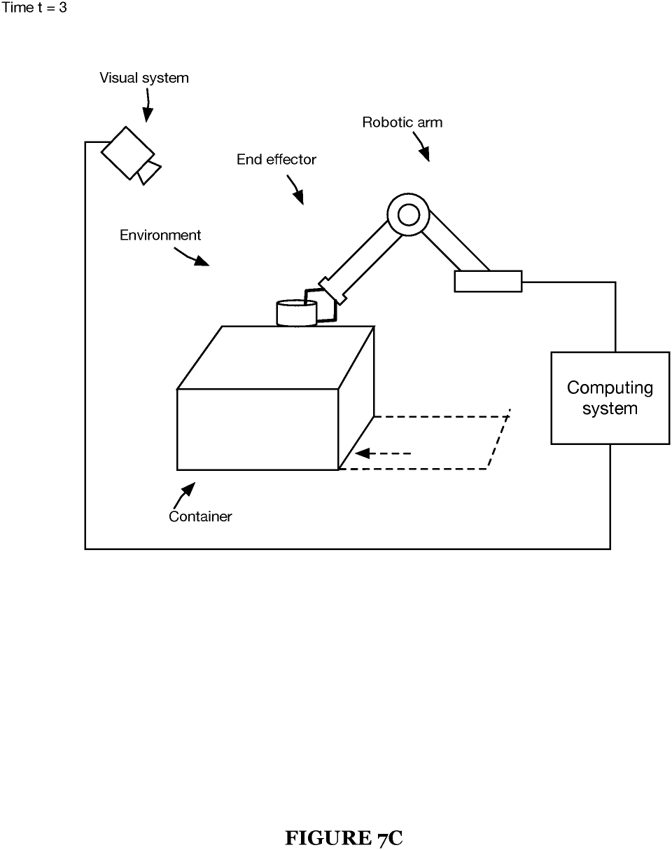

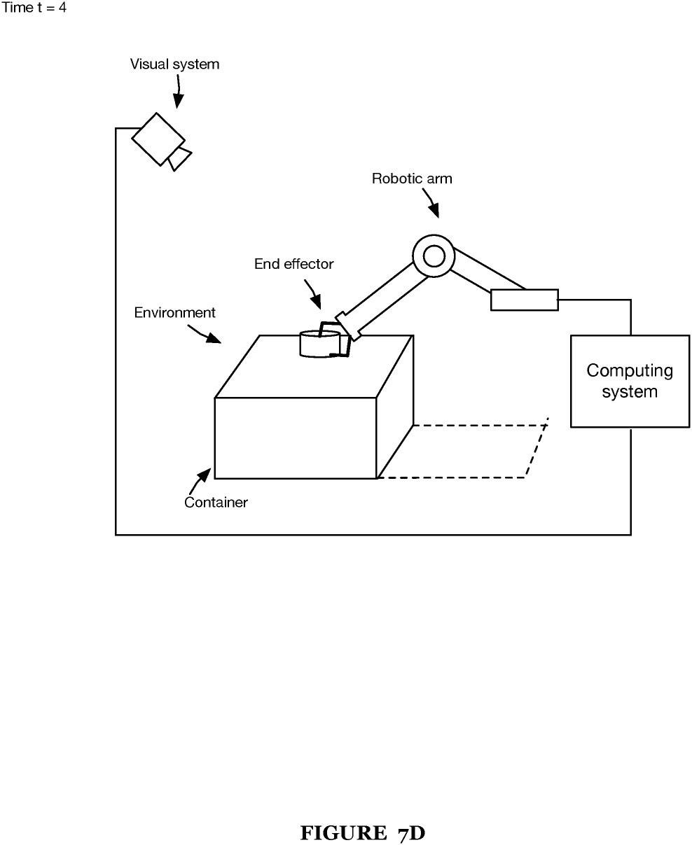

FIGS. 7A-D illustrate one example scenario of implementing the method by the system. The system can be equivalent to the system shown in FIGS. 2, 3A, 3B, or 4, and the method can be equivalent to the method shown in FIGS. 1 or 5.In a first illustrative example, the method can be used to carry a glass of water to a moving target while avoiding collisions with a moving obstacle. The motion specification can be defined to include pose constraints on the pose of the glass of water with respect to the goal marker, pose constraints on the glass with respect to the direction of gravity (e.g., keep the glass upright to avoid spilling, and allow for any yaw), acceleration constraints (e.g., don’t move the water too fast), and/or any other suitable constraints. After determining a motion specification and initial motion plan by the computing system (e.g., an offline planer module of FIG. 5), the computing system can control the robotic arm that is holding a glass of water upright in the end effector. A coaster can be identified and used to indicate the goal location for where the robotic arm needs to place the glass. A table vase can act as an obstacle for the robotic arm and the glass. If the table vase is moved (e.g., by the system, by an agent, by a human, etc.) while executing the motion plan, the computing system will re-plan online (e.g., using an online planner module of FIG. 5) to avoid the new position of the table vase. If the coaster is moved (e.g., by the system, by an agent, by a human, etc.) while executing the motion plan, the computing system can re-plan online to reach the new goal position of the coaster. If the glass of water slips (e.g. due to the system, an agent, a human, etc.) in the robot’s end effector while carrying it, the computing system (e.g. environment monitoring module) can sense the water slips and optionally update the environment state with the new position of the glass, and the computing system (e.g. online planner module) will re-plan online to position the end effector to correctly place the object on the coaster.

In a second illustrative example, the method can be used to perform a compliant insertion into a moving target (e.g., example depicted in FIGS. 7A-D). The example target can be a container to receive an insertion. Starting with an object in the end effector with a known in-hand pose (i.e. measured in the reference frame of the end effector), the robotic arm will begin moving toward a container detected on a conveyor (e.g., FIGS. 7A-B) using an external visual system (not attached to the robotic arm or end effector). Once the robotic arm reaches a pre-insertion pose (e.g., FIG. 7C), the robotic arm can move down to place the object inside of the container (e.g., FIG. 7D), compensating for contact forces with the walls of the container. The motion specification, in this example, can include a goal of moving to a pre-insertion pose with pose constraints wherein the target frame can be the in-hand object and the reference frame can be the container. The translation limits on the in-hand object with respect to the pre-insertion pose can be to move the in-hand object a predetermined distance above the container (e.g., less than 2 cm, less than 4 cm, less than 5 cm, less than 6 cm, less than 8, less than 10 cm, less than 12 cm, less than 14 cm, less than 20 cm, between 1-100 cm, between 8-12 cm, between 9-11 cm, more than 1 cm, more than 10 cm, more than 100 cm, etc.). In-hand object pose constraints can include allowing for a predetermined amount of pitch and roll. The yaw can be unconstrained or constrained to a predetermined amount. After reaching the pre-insertion pose, a new set of constraints can be used to achieve the next goal of moving to an insertion pose with active compliance. The pose constraints can include the same target and reference frames as used for the pre-insertion goal. The translation constraints can include placing the in- hand object in the center of the container while allowing for a predetermined amount of pitch and roll. The translation constraints can require that the in-hand object make contact with one or more surfaces (e.g., floor, wall, container, corner of two walls, etc.). Any yaw can be experienced by the system and/or a constraint on the yaw can be imposed by the motion specification. The motion specification can additionally define motion constraints. The motion constraints can include moving the end effector with active compliance to avoid a predetermined amount of force (e.g., more than 0.5 Newton, more than 1 Newton, more than 2 Newton, more than 3 Newton, between 0.5-1.5 Newton, etc.) and/or torque (e.g., more than 0.5 Newton-meters, more than 0.1 Newton-meters, more than 0.2 Newton-meters, more than 0.3 Newton-meters, between 0.05-0.15 Newton- meters, etc.).

In a third illustrative example, the method can be used to open a microwave door. The robotic arm can begin with the handle of the microwave door loosely held within a claw-shaped gripper that gives the handle freedom to rotate. If the door is initially parallel to the y-z plane and facing toward +x, then the goal can be to move the gripper past a lower limit on the x-position while remaining compliant to forces. The arm will greedily attempt to move in a straight line toward the goal, but as soon as the door swings and applies a force tangential to the straight-line path, the gripper will move to reduce the force by swinging along with the door. The motion specification, in this example, can include a goal with pose constraints wherein a target frame can be the gripper and the reference frame can be the base link of the robot. The translation limits of the gripper with respect to the microwave can require x to be greater than 20 cm and z can have no translation limits or a translation limit with respect to the height of the microwave and/or the microwave handle. The motion specification can additionally define motion constraints. The motion constraints can include constraints on a measurement of the force-torque sensor (e.g., a limit on the force, a limit on the torque, etc.) and/or constraints on any other measurement from any other sensor.

In a fourth illustrative example, the method can be used to keep the visual system pointed at a moving object while remaining compliant to forces on the gripper.

The visual system can be on-robot (e.g., attached to the robot, such as above the end effector, to the side of the end effector, etc.), next to the robot, and/or otherwise positioned. When the motion begins running, it immediately moves to point the visual system at a manufactured part on the table for inspection. If an external force (e.g., person, obstacle, etc.) moves the manufactured part, the robotic arm will move to keep the manufactured part centered in the visual system field of view. If an external force (e.g., person, obstacle, etc.) pushes on the end effector, the robotic arm will move to try to remain below the force and torque limits while always keeping the manufactured part centered in the visual system field of view. The motion specification, in this example, can include a goal with pose constraints wherein the target frame can be the manufactured part and the reference frame can be the on-arm visual system. The translation limits on the manufactured part with respect to the on-arm visual system can include keeping the manufactured part centered in the visual system field of view. The motion specification can additionally define motion constraints. The motion constraints can include moving the end effector with active compliance to avoid a predetermined force (e.g., more than 0.5 Newton, more than 1 Newton, more than 2 Newton, more than 3 Newton, between 0.5-1.5 Newton, etc.) and predetermined torque (e.g., more than 0.5 Newton-meters, more than 0.1 Newton-meters, more than 0.2 Newton-meters, more than 0.3 Newton- meters, between 0.05-0.15 Newton-meters, etc.).

In a fifth illustrative example, the method can be used to grasp a moving target with an early stopping force. The end effector can perform four motions in sequence: move into the pre-grasp pose defined in the target frame, move into the grasp pose defined in the target frame, close the gripper, and retract the gripper by a predetermined distance. The motion to the grasp pose may terminate early if the force limit is exceeded. If a person moves the target frame while the arm is moving, the system and method can adapt to the new goal position without interrupting the movement. In this case, the target frame can be the object to grasp and the reference frame can be the end effector. The motion specification can specify a predetermined distance between the object and the end effector, pose constraints related to moving to the grasp pose (e.g., keeping the end effector’s fingers aligned with the end effector’s movement direction), translation limits on the object with respect to the end effector, active compliance constraints (e.g., as a signal that the goal is achieved, such as the force on the gripper is larger than a predetermined amount), movement constraints (e.g., move along a predetermined trajectory, such as a straight line, a line with one 90 degree turn, etc.), end effector open and closed constraints, and/or any other suitable constraints.

In a sixth illustrative example, the motion specification can include a goal that is a disjunction of other goals: the goal is satisfied if any of the goals in the disjunction is satisfied. For example, there may be more than one end effector pose that allows for grasping an object. The offline planner can select which pose to aim for in the initial plan, and then the online planner could later choose to switch to a different pose.

More specifically, suppose the offline planner first plans to grasp the handle of a coffee mug, but then someone rotates the mug so that the handle is out of reach. The online planner can then change the target end effector pose to grasp the body of the mug instead.

In this specification, a robot is a machine having a base position, one or more movable components, and a kinematic model that can be used to map desired positions, poses, or both in one coordinate system, e.g., Cartesian coordinates or joint angles, into commands for physically moving the one or more movable components to the desired positions or poses. In this specification, a tool is a device that is part of and is attached at the end of the kinematic chain of the one or more moveable components of the robot. Example tools include grippers, welding devices, and sanding devices.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it, software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method for generating a motion plan for a robot in an environment, the method comprising: receiving data representing a motion specification for performing a task by a robot in an environment, wherein the motion specification specifies a goal and one or more constraints associated with the goal for accomplishing the task; determining, using a first planner module, an initial motion plan for the robot based on the motion specification, wherein the initial motion plan specifies a trajectory that satisfies the one or more constraints of the motion specification; initiating execution of the initial motion plan by the robot; monitoring, using one or more sensors, sensor data for detecting a first change in the environment; generating, using a second planner module, a first updated motion plan for the robot based on the first change in the environment that satisfies the one or more constraints specified in the motion specification; and executing the first updated motion plan by the robot.

Embodiment 2 is the method of Embodiment 1, further comprising monitoring, using the one or more sensors, sensor data for detecting a second change in the environment; generating, using the second planner module, a second updated motion plan for the robot based on the second change in the environment that satisfies the one or more constraints specified in the motion specification; and executing the second updated motion plan by the robot.

Embodiment 3 is the method of Embodiment 1 or 2, wherein the first planner module is an offline planner module or an online planner, and the second planner module is an online planner module.

Embodiment 4 is the method of any one of the Embodiments 1-3, wherein the second planner module is the same as the first planner module.

Embodiment 5 is the method of any one of the Embodiments 1-4, wherein initiating execution of the initial motion plan by the robot comprises: transmitting data representing the initial motion plan from the first planner module to a plan executor module; generating data representing a set of robotic commands by the plan executor module; transmitting data representing the set of robotic commands from the plan executor module to a robot controller module; and executing the set of robotic commands by the robot controller module such that the robot is caused to operate according to the initial motion plan.

Embodiment 6 is the method of any one of the Embodiments 1-5, wherein executing the first updated motion plan by the robot comprises: transmitting data representing the first updated motion plan from the second planner module to a plan executor module; blending, by the plan executor module, the first updated motion plan with the initial motion plan or a previous motion plan; and generating data, by the plan executor module, representing a set of robotic commands that, when executed, cause the robot to operate according to the first updated motion plan.

Embodiment 7 is the method of any one of the Embodiments 1-6, wherein the motion specification further includes a sequence of motion segment specifications, each motion segment specification defining a sub-goal for achieving the goal and respective constraints associated with the sub-goal.

Embodiment 8 is the method of any one of the Embodiments 1-7, wherein the motion specification can specify one or more of a conjunction constraint, a disjunction constraint, a geometric constraint, or a dynamic constraint.

Embodiment 9 is a system comprising one or more computers and one or more storage devices storing instructions that are operable, when executed by the one or more computers, to cause the one or more computers to perform the method of any one of embodiments 1-8.

Embodiment 10 is a computer storage medium encoded with a computer program, the program comprising instructions that are operable, when executed by data processing apparatus, to cause the data processing apparatus to perform the method of any one of embodiments 1-8.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

1. A method for generating a motion plan for a robot in an environment, the method comprising:
receiving data representing a motion specification for performing a task by a robot in an environment, wherein the motion specification specifies a goal and one or more constraints associated with the goal for accomplishing the task;
determining, using a first planner module, an initial motion plan for the robot based on the motion specification, wherein the initial motion plan specifies a trajectory that satisfies the one or more constraints of the motion specification;
initiating execution of the initial motion plan by the robot;
monitoring, using one or more sensors, sensor data for detecting a first change in the environment;
generating, using a second planner module, a first updated motion plan for the robot based on the first change in the environment that satisfies the one or more constraints specified in the motion specification; and
executing the first updated motion plan by the robot.

2. The method of claim 1, further comprising:
monitoring, using the one or more sensors, sensor data for detecting a second change in the environment;
generating, using the second planner module, a second updated motion plan for the robot based on the second change in the environment that satisfies the one or more constraints specified in the motion specification; and
executing the second updated motion plan by the robot.

3. The method of claim 1, wherein the first planner module is an offline planner module or an online planner, and the second planner module is an online planner module.

4. The method of claim 1, wherein the second planner module is the same as the first planner module.

5. The method of claim 1, wherein initiating execution of the initial motion plan by the robot comprises:
transmitting data representing the initial motion plan from the first planner module to a plan executor module;
generating data representing a set of robotic commands by the plan executor module;
transmitting data representing the set of robotic commands from the plan executor module to a robot controller module; and
executing the set of robotic commands by the robot controller module such that the robot is caused to operate according to the initial motion plan.

6. The method of claim 1, wherein executing the first updated motion plan by the robot comprises:
transmitting data representing the first updated motion plan from the second planner module to a plan executor module;
blending, by the plan executor module, the first updated motion plan with the initial motion plan or a previous motion plan; and
generating data, by the plan executor module, representing a set of robotic commands that, when executed, cause the robot to operate according to the first updated motion plan.

7. The method of claim 1, wherein the motion specification further includes a sequence of motion segment specifications, each motion segment specification defining a sub-goal for achieving the goal and respective constraints associated with the sub-goal.

8. The method of claim 1, wherein the motion specification can specify one or more of a conjunction constraint, a disjunction constraint, a geometric constraint, or a dynamic constraint.

9. A system comprising one or more computers and one or more storage devices storing instructions that when executed by one or more computers cause the one or more computers to perform respective operations, the operations comprising:
receiving data representing a motion specification for performing a task by a robot in an environment, wherein the motion specification specifies a goal and one or more constraints associated with the goal for accomplishing the task;
determining, using a first planner module, an initial motion plan for the robot based on the motion specification, wherein the initial motion plan specifies a trajectory that satisfies the one or more constraints of the motion specification;
initiating execution of the initial motion plan by the robot;
monitoring, using one or more sensors, sensor data for detecting a first change in the environment;
generating, using a second planner module, a first updated motion plan for the robot based on the first change in the environment that satisfies the one or more constraints specified in the motion specification; and
executing the first updated motion plan by the robot.

10. The system of claim 9, wherein the operations further comprise:
monitoring, using the one or more sensors, sensor data for detecting a second change in the environment;
generating, using the second planner module, a second updated motion plan for the robot based on the second change in the environment that satisfies the one or more constraints specified in the motion specification; and
executing the second updated motion plan by the robot.

11. The system of claim 9, wherein the first planner module is an offline planner module or an online planner, and the second planner module is an online planner module.

12. The system of claim 9, wherein the second planner module is the same as the first planner module.

13. The system of claim 9, wherein initiating execution of the initial motion plan by the robot comprises:
transmitting data representing the initial motion plan from the first planner module to a plan executor module;
generating data representing a set of robotic commands by the plan executor module;
transmitting data representing the set of robotic commands from the plan executor module to a robot controller module; and
executing the set of robotic commands by the robot controller module such that the robot is caused to operate according to the initial motion plan.

14. The system of claim 9, wherein executing the first updated motion plan by the robot comprises:
transmitting data representing the first updated motion plan from the second planner module to a plan executor module;
blending, by the plan executor module, the first updated motion plan with the initial motion plan or a previous motion plan; and
generating data, by the plan executor module, representing a set of robotic commands that, when executed, cause the robot to operate according to the first updated motion plan.

15. The system of claim 9, wherein the motion specification further includes a sequence of motion segment specifications, each motion segment specification defining a sub-goal for achieving the goal and respective constraints associated with the sub-goal.

16. The system of claim 9, wherein the motion specification can specify one or more of a conjunction constraint, a disjunction constraint, a geometric constraint, or a dynamic constraint.

17. One or more non-transitory computer-readable storage media storing instructions that when executed by one or more computers cause the one or more computers to perform respective operations, the respective operations comprising:
receiving data representing a motion specification for performing a task by a robot in an environment, wherein the motion specification specifies a goal and one or more constraints associated with the goal for accomplishing the task;
determining, using a first planner module, an initial motion plan for the robot based on the motion specification, wherein the initial motion plan specifies a trajectory that satisfies the one or more constraints of the motion specification;
initiating execution of the initial motion plan by the robot;
monitoring, using one or more sensors, sensor data for detecting a first change in the environment;
generating, using a second planner module, a first updated motion plan for the robot based on the first change in the environment that satisfies the one or more constraints specified in the motion specification; and
executing the first updated motion plan by the robot.

18. The one or more non-transitory computer-readable storage media of claim 17, wherein the operations further comprise:
monitoring, using the one or more sensors, sensor data for detecting a second change in the environment;
generating, using the second planner module, a second updated motion plan for the robot based on the second change in the environment that satisfies the one or more constraints specified in the motion specification; and
executing the second updated motion plan by the robot.

19. The one or more non-transitory computer-readable storage media of claim 17, wherein the first planner module is an offline planner module or an online planner, and the second planner module is an online planner module.

20. The one or more non-transitory computer-readable storage media of claim 17, wherein executing the first updated motion plan by the robot comprises:
transmitting data representing the first updated motion plan from the second planner module to a plan executor module;
blending, by the plan executor module, the first updated motion plan with the initial motion plan or a previous motion plan; and
generating data, by the plan executor module, representing a set of robotic commands that, when executed, cause the robot to operate according to the first updated motion plan.
